(19) United States
(12) Patent Application Publication
(10) Pub. No.: US 2006/0041924 A1
(43) Pub. Date: Feb. 23, 2006

(54) Digital television middleware service for home networking domains

(75) Inventors: Dennis Bushmitch, Somerset, NJ (US); Rajesh Khandelwal, Bridgewater, NJ (US); Alan Kaplan, Princeton, NJ (US)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Osaka (JP)

(21) Appl. No.: 10/924,242

(22) Filed: Aug. 20, 2004

(51) Int. Cl. H04N 7/173; H04N 7/16

(52) U.S. Cl. 725/132; 725/140; 725/152

(57) ABSTRACT

The middleware service interacts with data carousel data objects and acts as a bridge between the data carousel and subscribed control points. The middleware service can serve a variety of objects, including streams, applications, stream events and also enables new applications and services to be deployed on home networks. It connects devices without broadcast channel connectivity to broadcast channel-resident data services.

### BACKGROUND OF THE INVENTION

The present invention relates generally to data broadcasting and home networking. More particularly, the invention relates to a middleware technology applicable with digital television (DTV) systems that provides a bridge between DTV carousel mechanisms and home networking devices and protocols, such as, but not limited to UPnP-based networking.

Digital television (DTV) is implemented upon a set of standards that provide for the distribution of audio, video and data. As of this writing the MPEG standard is currently employed. Currently, broadcasters utilize the MPEG-2 standard to deliver motion pictures, audio and digital data, including executable application data, to subscribers and/or members of the public. In this regard, although the MPEG-2 standard is in current use, the inventions discussed herein are not intended to be limited to such standard. Indeed, the inventions are adapted to evolve with evolving standards, allowing the inventions to be exploited both today and in the future.

Television viewers are, of course, aware that digital television will allow audio and video content to be delivered for enjoyment in the home. What many may not realize, however, is that the DTV standards also define data storage, retrieval and broadcasting services whereby digital information other than the audio and video content may be delivered to the home. By way of example, when it is necessary to upgrade the software in the home user's DTV receiver or set-top box, one or more files containing the digital information needed to perform the upgrade may be transmitted as part of the MPEG transport stream (according to the DTV standards) to the receiver or set-top box. In some instances, this digital data may represent an executable program that is then launched and run on the local receiver or set-top box to effect the software upgrade.

The MPEG-2 standard, for example, provides a full set of protocols known as the digital storage medium command and control (DSM-CC) protocols that may be used to control the flow of this digital information between the video source and the receiving equipment. According to the roadmap outlined by the DSM-CC standards, after an initial link has been set up between two entities in a video delivery network (such as between the broadcast source and the user's receiver or set-top box) DSM-CC provides the functionality to continue the setup of an application session. Because this session setup happens at the interface between the network and the user equipment, DSM-CC defines a user-to-network protocol. Once the application session has been set up, further logical links are established between the video server and the receiver or set-top box. One logical link might be used for user data (like MPEG-2 coded video) and another logical link might be used to control what is happening on the user data link. This latter link is sometimes called the control link.

The actual protocol to be used on this control link is not specified by DSM-CC. However, DSM-CC defines a set of services (such as services to manipulate a video stream) in the server. These services can be used by the client on the receiver or set-top box. Because these services are primarily relevant between two user entities (such as the server and the client), the DSM-CC standard refers to them as the DSM-CC user-to-user interface (U-U interface). Thus the DSM-CC standards envision two fundamentally different interfaces, a user-network interface and a user-user interface. The user-network interface is used primarily for session setup and teardown and for managing the resources needed for the session. The user-user interface provides more application layer-oriented functions. For example, the user-user interface is used for application download communications and client-server communications.

Application Download Communication

Under the DSM-CC protocol, the user-user interface enables application download operations, which are primarily used for loading executable code from the server to a client. In a service on demand scenario, for example, a navigator application software program might be downloaded immediately after the session between the server and the client is set up. For such relatively straightforward download communication, the DSM-CC defines a simple message-based protocol, which implements a basic data flow-control mechanism.

There are, however, some applications where the simple data flow-control mechanism may not be sufficient. The DSM-CC thus provides for the use of a broadcasting approach to downloading digital data such as executable code from the server to a plurality of end users. To support broadcast download, the DSM-CC employs a data carousel which mediates the downloading of data. The data carousel supplies data continuously on a well defined download channel. Clients can tune to this channel, identify the data that is provided for download by analyzing periodically transmitted download control messages, and finally capturing the data the clients are interested in.

Client-Server Communication

After a session has been set up between the client and the server, the actual software application used to implement the service can then be started. Typically the service will employ one software component executed on the client and another software component on the server. Frequently the client software provides a user interface that will allow the user to navigate and use the actual service.

The client-server communication needed to support the software application during use is typically quite application-specific. For example, to implement VCR functionality in an interactive video on demand application, commands like fast forward, rewind or pause will typically be transmitted from the client to the server. These commands would be implemented using the user-user portion of the DSM-CC protocols.

User-User Object Carousel

The data carousel protocol makes use of non-flow-controlled download messages to provide periodic broadcast of data to a set of clients. While simple images may be distributed using the generic data carousel services, a more ambitious use of data carousel services is to provide an environment where the actual user-user objects behind a user service are physically delivered to clients. To support this type of functionality, DSM-CC specifies a user-user (U-U) object carousel and a broadcast interoperability protocol (BIOP). BIOP provides a standard way of embedding in broadcast carousels object references that describe actual locations of object representations within the same broadcast channel. U-U objects may include such objects such as directories, files, streams and service gateways.

Universal Plug-And-Play (UPnP) Standards

The plug-and-play concept has enjoyed widespread popularity in the personal computer and computer peripherals market. In that market, consumers have begun to increasingly demand products that “just work” without requiring complex installation and configuration tasks. Recently, the universal serial bus (USB) and plug-and-play technologies have been improved so that devices can now be automatically detected and the device drivers automatically installed when computer peripherals are first plugged in. While tremendous strides have been made in this regard, there still remain numerous instances where true plug-and-play (“it just works”) has not been realized.

In an effort to bring plug-and-play benefits to the networked device arena, a protocol known as the universal plug-and-play (UPnP) protocol has been proposed and is currently being explored by the industry. The UPnP standard is intended to bring the PC peripheral plug-and-play concept to the home network with the same ease of use and automatic configuration that users have come to expect with plug-and-play devices. Many believe that the home networking arena is an ideal one for implementing plug-and-play concepts, as that will allow the home network to begin to approach the ease of use that other consumer home appliances enjoy.

UPnP provides a framework of network layer protocols and application layer XML-based constructs:
automatic device network configuration
device and service description and discovery
device and service control and state interrogation
device state change notification and other eventing.

### SUMMARY OF THE INVENTION

While the DTV standards, such as the DSM-CC standards provide for basic object carousel access functionality, there are no self-describing discoverable home networking frameworks exposing object carousel data, and utilizing it for application launching. The present invention provides such functionality.

According to one aspect, the invention provides a middleware service that interconnects or interoperates between a data carousel broadcast transport stream configured according to a predefined object data carousel application program interface and a control point configured according to a predefined plug-and-play protocol. A first communication mechanism operates to communicate with the broadcast transport stream using said predefined application program interface to obtain information about objects available on said data carousel. A second communication mechanism operates to communicate with said control point using said predefined plug-and-play protocol and to thereby expose said control point to said objects available on said data carousel. Using the middleware service it is now possible to expose object carousel data to a wide variety of devices that support plug-and-play functionality

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system block diagram illustrating the middleware service of the invention being used in conjunction with a DTV server implementing a DSM-CC protocol object carousel API;

FIG. 2 is an implementation block diagram of a middleware service system;

FIG. 3 is a first exemplary message exchange diagram illustrating some of the principles of the invention;

FIG. 4 is a second exemplary message exchange diagram illustration application execution and control via a companion service;

FIG. 5 is an execution diagram illustrating the middleware service in an exemplary application; and

FIG. 6 is a functional block diagram illustrating the basic services provided by the DTV middleware service of the invention.

### DETAILED DESCRIPTION OF THE PREFERRED EMBODIMENTS

The following description of the preferred embodiment(s) is merely exemplary in nature and is in no way intended to limit the invention, its application, or uses.

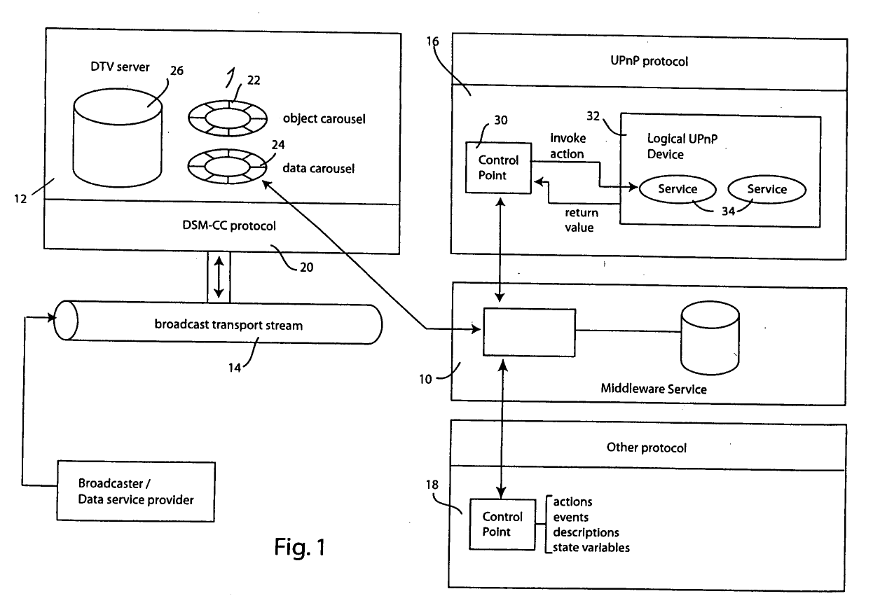

Referring first to FIG. 1, the middleware service of the invention 10 will now be described in an operational environment that includes a digital TV server 12 that implements a DSM-CC protocol by which digital data are supplied over a suitable communication channel such as broadcast transport stream 14 to client devices. As illustrated in FIG. 1, the middleware service 10 provides bridging connectivity to operatively interconnect with devices utilizing the UPnP protocol (shown generally at 16) and also with other protocols (shown generally at 18).

The DTV server 12 preferably adheres to a digital storage media command and control protocol, such as the DSM-CC protocol 20. This protocol defines mechanism for periodically delivering digital data to clients. These mechanisms are configured as carousels. Thus in FIG. 1, an object carousel 22 and a data carousel 24 have been illustrated. These carousels operate to periodically deliver data from server 26 to the client devices that have tuned to the proper channel to receive this data.

The middleware service 10 interacts with the DTV server 12 to communicate the objects served by object carousel 22 to subscribed control points and services that are implemented in accordance with a plug-and-play protocol such as UPnP protocol 16 or another protocol 18, such as APIs supported by the Open Services Gateway Initiative (OSGi) framework, for example. The middleware service 10 has extended support for application objects, permitting execution control on broadcast enabled and broadcast disconnected devices. Middleware service 10 exposes carousel events to home networking devices that are implemented according to a plug-and-play protocol, making these carousel events (of the DSM-CC protocol) appear to the networked device as an event or action (as defined by the plug-and-play standard).

In order to better appreciate how the middleware service 10 provides a bridge between the DTV DSM-CC protocol and a plug-and-play protocol, such as the UPnP protocol, a basic understanding of plug-and-play protocols will be helpful. While the UPnP protocol has currently gained industry-wide favor, it is envisioned that other protocols may be developed to either expand upon or replace the UPnP protocol in the future. Thus the middleware service 10 of FIG. 1 is shown as being capable of interoperability with not only the UPnP protocol 16 but other protocols 18, as well.

The UPnP protocol defines three basic abstractions: devices, services, and control points. A UPnP device can be any entity on a network that implements the protocols required by the UPnP architecture. The UPnP standardizes the protocols through which a device communicates, rather than the application programming interfaces that are used to connect to the device. Thus a device that speaks the required protocols is a UPnP device.

A UPnP service is a unit of functionality implemented by a device. A device can implement zero or more services. Each service is typically defined as a set of methods or actions, each with a set of optional input and output parameters and an optional return value. In general, a given device type will have a set of required services that the device must implement. For example, a CD player would have a service that provides the ability to play, stop and pause the audio content.

A UPnP control point is an entity on the network that invokes the functionality provided by a device. One can think of the control point as a client and the device as the server.

In FIG. 1, control point 30 is illustrated in its interactive role with a logical UPnP device 32. The control point invokes an action, by sending a properly configured communication to device 32 thereby invoking one or more of the device's services 34. The device may then provide a return value to the control point, as illustrated. Thus, in general, any entity that invokes the services of a UPnP device is a control point. This allows UPnP devices to also function as control points, whereby one device can invoke the services or monitor state changes in another device. It is upon this basic communication scheme that a peer-to-peer network may be built.

A UPnP device can provide many different types of services, depending on the functionality desired. Often these services will have an associated state table comprising a grouping of the services state variables. Each state variable would have a name, a type and a value, and would be used to keep track of what particular mode of operation or function is being provided. For example, a service that renders or plays audio tracks might keep a state variable that contains the URL of the current track being played. When the track changes, the service would send a state change notification with the new URL to all control points that have registered to receive events from the service.

The UPnP protocol provides a framework whereby control points can discover devices, invoke actions on a device's services and subscribe to events. Devices, on the other hand, respond to control point messages by invoking actions and sending events when state variables change. To support this basic interaction between control point and device, all UPnP devices adhere to the following phases of operation:
Addressing. The device joins the network, acquiring a unique address that others can use to communicate with it;
Description. The device summarizes its services and capabilities in a standard format;
Discovery. The device is found by control points and the device's description information is retrieved;
Control. The device handles requests -from control points to invoke actions;
Eventing. The device's services notify registered control points when internal state changes occur; and
Presentation. The device optionally provides an HTML-based administrative interface to allow for direct manipulation and monitoring.

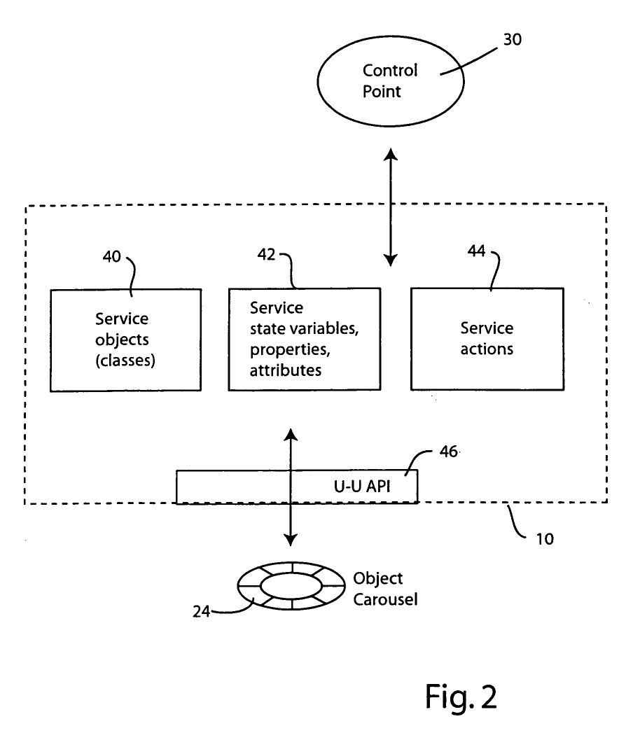

The middleware service may be implemented using one or more servers having suitable connectivity to the DTV server 12 and to the end user systems which implement a plug-and-play protocol. An example of such a server implementation has been illustrated in FIG. 2. It will be appreciated that the components and modules that comprise the implementation of FIG. 2 may be deployed on a single server, or they may be distributed across multiple servers, which can be either located in a common facility or distributed throughout the world. Referring to FIG. 2, the middleware service is shown generally at 10. The middleware service communicates with the object carousel 24 and also with a control point 30 that may be associated with at least one logical device. Although not required in all implementations, the logical device associated with the control point 30 may be configured to support at least one service.

The middleware service 10 encapsulates service objects 40, which may implemented as classes. The middleware service further includes a data store of service state variables, properties and attributes, shown diagrammatically at 42. The middleware service includes a set of functional programs for performing service actions, shown diagrammatically at 44.

The middleware service 10 is configured to initiate a message exchange with the object carousel 24, in order to determine what services are available. Examples of such services include providing directories, files, streams and service gateways. Information obtained from the object carousel 24 about its capabilities are then stored as service state variables at 42.

The middleware service is further adapted to communicate with the control point 30, adhering to the protocols utilized by the control point 30. For purposes of illustration, the UPnP protocol has been illustrated. Of course, other protocols are also possible within the scope of the invention. Communication can be effected by any suitable means, such as by XML document.

The control point 30 establishes communication with communication module 46 and initially interacts with the middleware service 10 to register a subscription to one or more services being made available through the middleware service 10. The control point subscribes to services that the user is interested in. Knowledge of which services are available is obtained by consulting the object carousel data store 44. As will be more fully explained below, the middleware service then includes the subscribed control point 30 in disseminating any pertinent information about the services being subscribed to. For example, if a particular service subscribed to becomes available or unavailable, this change of state information would be sent to control point 30.

The middleware service operates to encapsulate data objects from the object carousel 24 and to expose them through a well established protocol, such as a UPnP protocol. Thus, if the end user has requested delivery of a particular file or stream, this information is obtained from the object carousel (by utilizing the middleware service) and then delivered or routed to the end user device. The middleware service 10 performs the necessary protocol conversion, making the object carousel information appear to the end user device as if it had been provided to that device in its native plug-and-play form.

The middleware service thus effectively extends the reach of the broadcaster and data service provider, by allowing a wide range of plug-and-play devices to utilize the information and services provided by the broadcaster or data service provider. For example, a properly configured UPnP device, such as a personal computer, cellular telephone, or home network appliance, could be made to receive a media stream originally designed to be delivered to broadcast receiving devices like television sets. The middleware service thus has the potential to greatly enhance the value of broadcast services.

In some instances there may be a service offered by the broadcaster, such as an executable application, that cannot be directly supported by the end user device. The device may not be broadcast enabled, for example, or the device may be disconnected from the broadcast communication channel. The middleware service of the invention has the ability to host applications in this instance. Specifically, the middleware service 10 includes a host application execution environment 50, that may be used to allow a device to give the appearance of running the application, even though the application is actually being run elsewhere (on the middleware service, for example). Thus the middleware service provides companion service functionality. As will be seen, the ability to offer companion service functionality has wide-reaching implications for the providing of DTV services to plug-and-play devices of all descriptions, ranging from a low-featured set-top box to a full-featured with broadband connection.

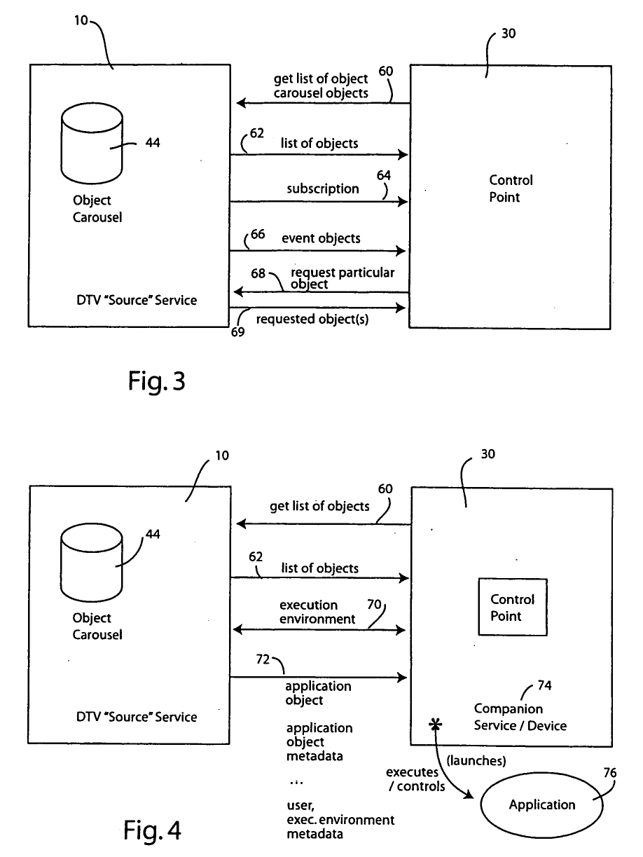

Before presenting a more detailed description of the middleware service, a few examples of the service will be presented. Referring to FIG. 3, the middleware service 10 is illustrated in communication with control point 30. FIG. 3 shows the types of messages that are passed between service 10 and control point 30 in order to supply event objects to the control point. In FIG. 3 it is assumed that the data store 44 containing object carousel data has already been populated by suitable communication with the DTV server. Thus communication begins when, as illustrated at 60, control point 30 sends a message to the middleware service requesting a list of object carousel objects. The middleware service responds at 62 with the requested list. The control point 30 then makes a subscription 64 identifying those objects which the user is interested in subscribing to. As the requested objects become available, the middleware service sends them to the control point 30. Thus event objects 66 are communicated to the control point 30. The control point 30 may also request particular objects, as illustrated at 68. In response, the requested object or objects are returned, as illustrated at 69.

FIG. 4 shows a similar exchange of messages that would be communicated in order to implement a companion service. As before, the control point 30 sends message 60 to get a list of objects and the middleware service 10 responds with message 62 providing the requested list. Thereafter, both middleware service and control point exchange information at 70 so that both sides are aware of the execution environment that is available on the device which will execute the application. Then, at 72, the middleware service 10 communicates the application object data, application object metadata, and any other necessary information, such as user information, execution environment information and other metadata to the control point 30.

In some instances, the control point (or a logical device that is controlled by the control point) will have sufficient capability to execute the application object directly. In other instances, the control point or associated device may not have the necessary environment for computing capabilities. In such case, the middleware service 10 provides the needed execution platform, thereby associating with the control point 30 a companion service 74 that has the capability to execute and control the launched application 76. Thus, although some, or all, of the execution platform may be provided by the middleware service. From the viewpoint of the control point and its associated devices, the companion service appears the same as if it had been hosted on the control point or device directly. The service and/or control point may then interrogate the requesting entity's companion service about its execution environment available at that entity, to determine the suitability of the application being deployed there.

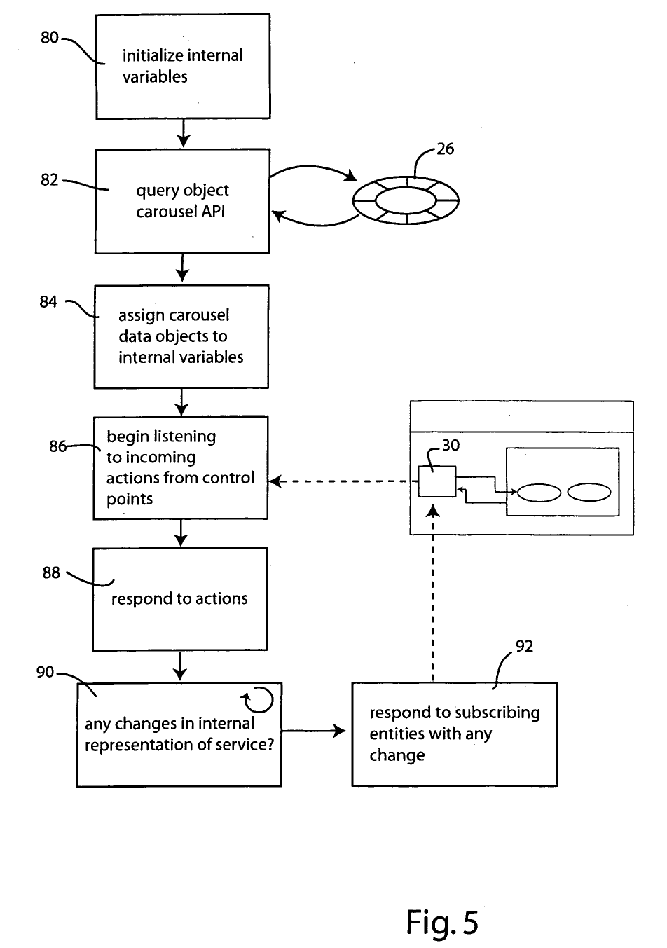

In operation, the middleware service 10 executes a sequence of steps, illustrated in FIG. 5. Beginning at step 80, the service initializes its internal variables and then queries the object carousel 26 through its provided API, as at step 82. The middleware service then assigns carousel data objects to its internal variables, at 84 and begins listening, at 86, to incoming actions from control points 30. The service response to actions, as at 88, and continues to monitor for any changes in its internal representation of the services available from the object carousel (step 90). When changes are detected, the service responds to subscribing entities by providing information indicative of the detected changes (step 92).

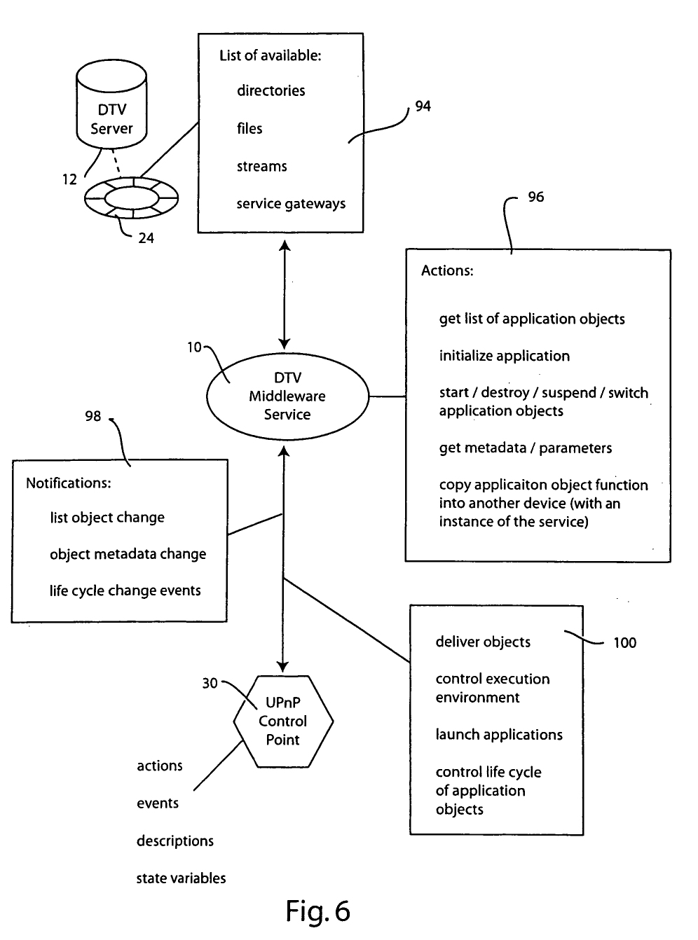

Having thus described the middleware service in some of its presently preferred forms, FIG. 6 will now be used to summarize the basic capabilities and features of the middleware service 10. As previously explained, the middleware service 10 may be seen as a bridge between the DTV server 12 and a plug-and-play control point such as UPnP control point 30. FIG. 6 shows examples of information typically used to implement the DTV middleware service. As illustrated, the DTV server makes available lists of directories, files, streams and service gateways. This is illustrated diagrammatically at 94. Thus in implementing the DTV middleware service, a suitable data store will be provided to contain information of the type listed in block 94. The specific details about the storage requirements and nature of the data may be found by consulting the applicable MPEG standards for the DSM-CC protocol.

The DTV middleware service 10 is programmed to provide a plurality of basic methods or actions. These have been listed at 96. As previously discussed, in connection with FIG. 2, these specific actions performed by the middleware service can be implemented using one or more software components or modules. These modules can be implemented in a single server, or they may be distributed across several servers. As illustrated at 96, the middleware service is programmed to communicate with the DTV server to get a list of application objects. The DTV middleware service is also programmed to interact with the control point 30 (or with a companion service) to initialize applications launched by the DTV server 12. Middleware service 10 thus has the ability to control execution of applications, including the ability to start, destroy, suspend, and switch application objects. In order to control the application environment, the middleware service 10 also performs actions to get metadata and parameters through interaction with the control point 30 and/or through other applications that will be hosting the launched application. Finally, the middleware service is programmed to copy an application object function into another device which is running an instance of the service. In this way, functionality can be propagated across multiple devices, if desired.

In one presently preferred embodiment, the middleware service is configured to support the following actions:
Get the list of application objects
Initialize application
Start/destroy/suspend/switch application objects
Get metadata/parameters
Copy application object function into another device with an instance of the service (included Source and Target URLs)—note, in some instances just an FTP server may be present, where there is a minimal requirement to accept the carrousel object

In addition to the aforementioned actions, the DTV middleware service 10 is also programmed to provide message notifications to its subscribers. The notifications include, for example, listing object changes, providing object metadata change information and providing life cycle change event information. This set of notification functions has been illustrated at 98. In one presently preferred embodiment, the middleware service 10 provides the following service notifications:
Notifications when the list objects themselves (applications) change—note that a state variable can be responsible for this
Notifications when metadata pertaining to objects change
Notification of application life cycle change events—note these can be evented (GENA) state variables, or attributes/elements/properties returned by actions invoked on the service.

In addition to the above notifications, the middleware service may also provide further state variable information, action information and notifications. This would include, for example, exposing timing information for event synchronization, such as whatever events are coming from the real-time transports streams as UPnP events, actions and state variables. These would include, for example, Normal Play Time (NPT) information. The middleware service would implement an action to get the NPT and would provide event notification when the NPT changes.

The net effect of the actions and notifications provided by middleware service 10 is summarized in block 100. Thus the middleware service operates to deliver objects, control execution environment, launch applications and control life cycle of application objects. The middleware service 10 may also be configured to supply pointers to applications (which may include protocol information on how and where to get the applications—which can be the URL where the application can be obtained). Through these functions, the middleware service is able to seamlessly integrate with the protocol of the control point 30, and with any associated devices and services operating under that protocol. Thus the middleware service 10 is able to effect changes in actions, events, descriptions and state variables associated with the control point and its associated devices and services.

In one presently preferred embodiment, the middleware service 10 provides a rich set of metadata pertaining to application objects. This metadata includes:
Name
Class files—note that the carousel is organized as a file system; this file system could be un-mounted upon channel switch
Application ID
Application priority
Application Parameters (e.g., visibility, icons, etc.)
Autostart/Manual Control flags

In addition to the above, the middleware service may also provide further metadata associated with DTV events (synchronization with stream events), application resource requirements, default user preferences and profiles, and “playlists” of application objects.

The middleware service can provide a handle for internet protocol (IP) channel “interconnection” point for other applications. This can be included in the metadata. Additional metadata describing the IP communication parameters may include:
Transport protocols, such as ftp, http, rtsp, rtp and so forth
Quality of Service (QoS) characteristics.

If desired, the middleware service may be configured to provide other, extended functionality. For example, to run mulitimedia home platform (MHP) applications (e.g., Java applications), the MHP stack needs to be present at the box, but the box might lack broadcast or broadband connection. However, the device might be home network connected (i.e., a full-fledged UPnP device).

Applications coming in over object carousel can be sent to other boxes for execution (e.g., a new UPnP service can be delivered to another box). In this case, the control point discovers new applications as they are made available. The control point would instruct some other device to download a new application object from the primary source service. The middleware service delivers applications, their components and methods to obtain those necessary execution environment components.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A middleware service operable to interconnect between a data carousel broadcast transport stream configured according to a predefined object data carousel application program interface and a control point configured according to a predefined plug-and-play protocol, comprising:
a first communication mechanism operable to communicate with said broadcast transport stream using said predefined application program interface to obtain information about objects available on said data carousel;
a second communication mechanism operable to communicate with said control point using said predefined plug-and-play protocol and to thereby expose said control point to said objects available on said data carousel.

2. The middleware service of claim 1 further comprising a data store for applying persistency rules to said objects available on said data carousel.

3. The middleware service of claim 1 further comprising subscription mechanism accessible by said control point and operable to identify said control point to receive messages from said middleware service related to said objects available on said data carousel.

4. The middleware service of claim 1 further comprising a document serving mechanism that serves a document describing actions available by the middleware service.

5. The middleware service of claim 4 wherein said document serving mechanism serves a document further describing state variables associated with said objects available on said data carousel.

6. The middleware service of claim 4 wherein said document serving mechanism serves an XML document describing actions available by the middleware service.

7. The middleware service of claim 1 wherein said first communication mechanism determines information about objects available on said data carousel selected from the group consisting of:
applications available,
carousel objects available,
pointers to applications,
protocol information on how to access applications,
metadata pertaining to application execution environment,
operating system priority settings,
metadata used to launch applications,
metadata used to terminate applications, and
application lifecycle timing information.

8. The middleware service of claim 1 wherein said first communication mechanism determines metadata information about application objects available on said data carousel selected from the group consisting of:
name,
class file
application ID,
application priority,
application parameters,
application visibility parameters,
application icon parameters,
autostart, and
manual control flags.

9. The middleware service of claim 1 further comprising change notification mechanism operable to monitor information received from said first communication mechanism, to detect changes in state associated with said received information and to provide notification information about said changes in state through said second communication mechanism.

10. The middleware service of claim 9 wherein said information received includes the identity of objects available on said data carousel and wherein said notification information communicates a when a change in the objects available occurs.

11. The middleware service of claim 9 wherein said information received includes information pertaining to application object life cycle and wherein said notification information communicates a when a change in said life cycle occurs.

12. The middleware service of claim 1 further comprising host application environment for executing application objects made available by said middleware service.

13. The middleware service of claim 3 further comprising event notification mechanism that provides state change information to said control point based on negotiations between said control point and said subscription mechanism.

14. The middleware service of claim 1 wherein said middleware service delivers objects to subscribing entities.

15. The middleware service of claim 1 wherein said middleware service controls the execution environment of application objects.

16. The middleware service of claim 1 further comprising mechanism for launching applications.

17. The middleware service of claim 16 wherein said applications can be launched at devices regardless of whether those devices are directly supported by said data carousel broadcast transport stream.

18. The middleware service of claim 1 further comprising companion service that launches application objects on devices that are not directly supported by said data carousel broadcast transport stream.

19. The middleware service of claim 1 further comprising a mechanism whereby said control point can instruct another service instance to download and launch an application available at a source service instance.

20. The middleware service of claim 1 further comprising a mechanism that provides a list of carousel objects available via said data carousel broadcast transport stream.

21. The middleware service of claim 1 further comprising a mechanism that provides pointers to applications including protocol information on how and where to get applications.

22. The middleware service of claim 1 further comprising a mechanism for providing metadata pertaining to the execution environment of an application.

23. The middleware service of claim 1 further comprising a mechanism for providing metadata used in controlling the life cycle of an application object.

24. The middleware service of claim 1 further comprising a mechanism that supports services selected from the group consisting of:
getting list of application objects;
initialize application;
start, destroy, suspend or switch application objects;
get metadata and parameters; and
copy application object functions into another device with an instance of the service.

25. The middleware service of claim 1 further comprising a mechanism that makes available metadata selected from the group consisting of:
digital television events;
digital television events in synchronism with stream events;
application resource requirements;
default user preferences or profiles; and
playlists of application objects.

26. The middleware service of claim 1 further comprising a mechanism that mediates state variables selected from the group consisting of:
timing information for event synchronization;
normal play time;
event notification when normal play time changes.

27. The middleware service of claim 1 further comprising a requesting entity having a companion service and wherein said middleware service includes a mechanism whereby said control point may interrogate the requesting entity's companion service about its execution environment and thereby determine the suitability of the application deployed by said companion service.

28. The middleware service of claim 1 further comprising a mechanism to handle internet protocol channel interconnection points for other applications.

29. The middleware service of claim 28 further comprising a mechanism for describing the internet protocol communication parameters.

30. The middleware service of claim 29 wherein said communication parameters include transport protocols.

31. The middleware service of claim 29 wherein said communication parameters include quality of service characteristics.

32. The middleware service of claim 9 wherein said information received includes metadata pertaining to objects available on said data carousel and wherein said notification information communicates a when a change in said metadata occurs.
